(19) United States
(12) Patent Application Publication
(10) Pub. No.: US 2024/0022401 A1
(43) Pub. Date: Jan. 18, 2024

(54) RANDOMIZATION OF ENCRYPTION OF FILE BLOCKS

(71) Applicant: Profian Inc., Raleigh, NC (US)

(72) Inventors: Michael Hingston McLaughlin Bursell, Essex (GB); Nathaniel Philip McCallum, Cary, NC (US)

(21) Appl. No.: 17/865,154

(22) Filed: Jul. 14, 2022

(51) Int. Cl. H04L 9/08; G06F 21/60

(52) U.S. Cl. CPC H04L 9/0869; G06F 21/602

(57) ABSTRACT

A method for providing randomized encryption for file blocks including receiving a plurality of file blocks, selecting at least one encryption scheme for the plurality of file blocks, determining a first encryption order for the plurality of file blocks, encrypting, at a first time, the plurality of file blocks with the at least one encryption scheme in the first encryption order to produce a first plurality of encrypted file blocks, determining a second encryption order for the plurality of file blocks, the second encryption order being different from the first encryption order, and encrypting, at a second time, the plurality of file blocks with the at least one encryption scheme in the second encryption order to produce a second plurality of encrypted file blocks.

### TECHNICAL FIELD

This specification relates to file block encryption and, in particular, to providing randomized encryption of file blocks.

### BACKGROUND

Computing devices can include one or more file systems for data storage. Each file system may be accessible to processes running on the computing device and users of the computing device. In addition, each file system may be accessible to external processes and users in communication with the computing device. The data stored in each file system may be encrypted for protection against unauthorized processes or users. In some cases, the data is encrypted (and re-encrypted) in blocks to provide manageable encryption workloads. However, the order in which the file blocks are encrypted can indicate the significance of the data included in each file block. As such, certain file blocks may have an increased vulnerability to coordinated attacks from unauthorized processes or users.

### SUMMARY

At least one aspect of the present disclosure is directed to a method for providing randomized encryption for file blocks. The method includes receiving a plurality of file blocks, selecting at least one encryption scheme for the plurality of file blocks, determining a first encryption order for the plurality of file blocks, encrypting, at a first time, the plurality of file blocks with the at least one encryption scheme in the first encryption order to produce a first plurality of encrypted file blocks, determining a second encryption order for the plurality of file blocks, the second encryption order being different from the first encryption order, and encrypting, at a second time, the plurality of file blocks with the at least one encryption scheme in the second encryption order to produce a second plurality of encrypted file blocks.

In one embodiment, the first and second encryption orders are random orders. In some embodiments, determining the first and second encryption orders for the plurality of file blocks includes receiving random encryption orders from a random order generator. In various embodiments, selecting the at least one encryption scheme for the plurality of file blocks includes selecting a first encryption scheme and a second encryption scheme, the second encryption scheme being different than the first encryption scheme. In certain embodiments, a first portion of the plurality of file blocks are encrypted with the first encryption scheme and a second portion of the plurality of file blocks are encrypted with the second encryption scheme.

In some embodiments, at least one file block encrypted with the first encryption scheme to produce the first plurality of encrypted file blocks is encrypted with the second encryption scheme to produce the second plurality of encrypted file blocks. In one embodiment, each file block of the plurality of file blocks includes a portion of data from a file system. In certain embodiments, the method includes evaluating a significance of the data included in the plurality of file blocks and determining an encryption frequency based on the significance of the plurality of file blocks. In various embodiments, an amount of time between the first time and the second time corresponds to the encryption frequency.

In one embodiment, the method includes evaluating a significance of the data included in the plurality of file blocks, comparing the significance of the data to a significance threshold, and scheduling the encryptions of the plurality of file blocks based on a result of the comparison to the significance threshold. In some embodiments, the method includes, scheduling the encryptions of the plurality of file blocks during off-peak demand periods in response to a comparison result falling below the significance threshold and scheduling the encryptions of the plurality of file blocks during on-peak and/or off-peak demand periods in response to a comparison result rising above the significance threshold. In various embodiments, a first cost associated with performing the encryptions of the plurality of file blocks during off-peak demand periods is less than a second cost associated with performing the encryptions of the plurality of file block during on-peak demand periods. In certain embodiments, the method includes evaluating a significance of the data included in the plurality of file blocks, comparing the significance of the data to a significance threshold, and selecting at least one computing service to perform the encryptions of the plurality of file blocks based on a result of the comparison to the significance threshold.

In some embodiments, the method includes selecting at least one first computing service configured to perform the encryptions of the plurality of file blocks at a first processing rate in response to a comparison result falling below the significance threshold and selecting at least one second computing service configured to perform the encryptions of the plurality of file blocks at a second processing rate in response to a comparison result rising above the significance threshold, the second processing rate being faster than the first processing rate. In one embodiment, the method includes storing the first plurality of encrypted file blocks in a file system and replacing the first plurality of encrypted file blocks with the second plurality of encrypted file blocks.

Another aspect of the present disclosure is directed to a system for providing randomized encryption for file blocks. The system includes at least one memory for storing computer-executable instructions and at least one processor for executing the instructions stored on the memory. The execution of the instructions programs the at least one processor to perform operations that include receiving a plurality of file blocks, selecting at least one encryption scheme for the plurality of file blocks, determining a first encryption order for the plurality of file blocks, encrypting, at a first time, the plurality of file blocks with the at least one encryption scheme in the first encryption order to produce a first plurality of encrypted file blocks, determining a second encryption order for the plurality of file blocks, the second encryption order being different from the first encryption order, and encrypting, at a second time, the plurality of file blocks with the at least one encryption scheme in the second encryption order to produce a second plurality of encrypted file blocks.

In one embodiment, the first and second encryption orders are random orders. In some embodiments, determining the first and second encryption orders for the plurality of file blocks includes receiving random encryption orders from a random order generator. In various embodiments, selecting the at least one encryption scheme for the plurality of file blocks includes selecting a first encryption scheme and a second encryption scheme, the second encryption scheme being different than the first encryption scheme. In certain embodiments, a first portion of the plurality of file blocks are encrypted with the first encryption scheme and a second portion of the plurality of file blocks are encrypted with the second encryption scheme.

In some embodiments, at least one file block encrypted with the first encryption scheme to produce the first plurality of encrypted file blocks is encrypted with the second encryption scheme to produce the second plurality of encrypted file blocks. In one embodiment, each file block of the plurality of file blocks includes a portion of data from a file system. In certain embodiments, execution of the instructions programs the at least one processor to perform operations that include evaluating a significance of the data included in the plurality of file blocks and determining an encryption frequency based on the significance of the plurality of file blocks. In various embodiments, an amount of time between the first time and the second time corresponds to the encryption frequency.

In one embodiment, execution of the instructions programs the at least one processor to perform operations that include evaluating a significance of the data included in the plurality of file blocks, comparing the significance of the data to a significance threshold, and scheduling the encryptions of the plurality of file blocks based on a result of the comparison to the significance threshold. In some embodiments, execution of the instructions programs the at least one processor to perform operations that include scheduling the encryptions of the plurality of file blocks during off-peak demand periods in response to a comparison result falling below the significance threshold and scheduling the encryptions of the plurality of file blocks during on-peak and/or off-peak demand periods in response to a comparison result rising above the significance threshold. In various embodiments, a first cost associated with performing the encryptions of the plurality of file blocks during off-peak demand periods is less than a second cost associated with performing the encryptions of the plurality of file block during on-peak demand periods. In certain embodiments, execution of the instructions programs the at least one processor to perform operations that include evaluating a significance of the data included in the plurality of file blocks, comparing the significance of the data to a significance threshold, and selecting at least one computing service to perform the encryptions of the plurality of file blocks based on a result of the comparison to the significance threshold.

In some embodiments, execution of the instructions programs the at least one processor to perform operations that include selecting at least one first computing service configured to perform the encryptions of the plurality of file blocks at a first processing rate in response to a comparison result falling below the significance threshold and selecting at least one second computing service configured to perform the encryptions of the plurality of file blocks at a second processing rate in response to a comparison result rising above the significance threshold, the second processing rate being faster than the first processing rate. In one embodiment, execution of the instructions programs the at least one processor to perform operations that include storing the first plurality of encrypted file blocks in a file system and replacing the first plurality of encrypted file blocks with the second plurality of encrypted file blocks.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a block diagram of an example computing device.

FIG. 2 is a block diagram of another example computing device.

FIG. 3 is a block diagram of a computing device in accordance with at least one embodiment described herein.

FIG. 4 is a flow diagram of a method for providing randomized encryption of file blocks in accordance with at least one embodiment described herein.

FIG. 5 is a diagram of an example file system including a plurality of file blocks in accordance with at least one embodiment described herein.

FIG. 6A is a diagram of an example encryption arrangement in accordance with at least one embodiment described herein.

FIG. 6B is a diagram of an example encryption arrangement in accordance with at least one embodiment described herein.

FIG. 7 is a diagram of an example encryption arrangement in accordance with at least one embodiment described herein.

FIG. 8A is a diagram of an example encryption arrangement in accordance with at least one embodiment described herein.

FIG. 8B is a diagram of an example encryption arrangement in accordance with at least one embodiment described herein.

FIG. 9A is a diagram of an example encryption arrangement in accordance with at least one embodiment described herein.

FIG. 9B is a diagram of an example encryption arrangement in accordance with at least one embodiment described herein.

FIG. 10 is a diagram of an example encryption arrangement in accordance with at least one embodiment described herein.

FIG. 11 is a diagram of an example encryption arrangement in accordance with at least one embodiment described herein.

FIG. 12 is a flow diagram of a method for generating an encryption profile for a file system in accordance with at least one embodiment described herein.

FIG. 13 is a diagram of an exemplary hardware and software system implementing the systems and methods described herein, in accordance with some embodiments.

### DETAILED DESCRIPTION

Systems and methods for providing randomized encryption of file blocks are provided herein. In at least one embodiment, at least one encryption scheme is selected for a plurality of file blocks of a file system. At a first time, the plurality of file blocks are encrypted with the at least one encryption scheme in a first encryption order to produce a first plurality of encrypted file blocks. In some examples, the first plurality of encrypted file blocks are stored in the file system. At a second time, the plurality of file blocks are encrypted with the at least one encryption scheme in a second encryption order that is different than the first encryption order to produce a second plurality of encrypted file blocks. In certain examples, the second plurality of encrypted file blocks replace the first plurality of encrypted file blocks in the file system.

Reference will now be made in detail to background examples and some embodiments of the invention, examples of which are illustrated in the accompanying drawings. It will be appreciated that, for simplicity and clarity of illustration, where considered appropriate, reference numerals may be repeated among the figures to indicate corresponding or analogous elements. In addition, numerous specific details are set forth to provide a thorough understanding of the exemplary embodiments described herein. However, it will be understood by those of ordinary skill in the art that the exemplary embodiments described herein may be practiced without these specific details.

### Examples of Confidential Computing Systems

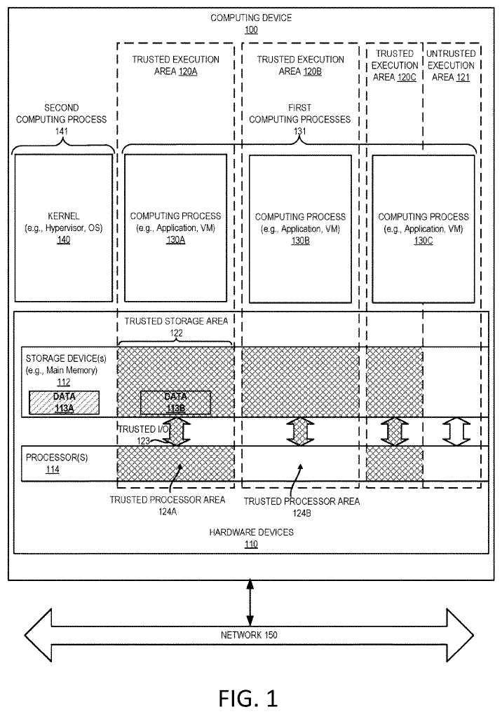

FIG. 1 depicts an illustrative architecture of elements of a computing device 100, in accordance with an embodiment of the present disclosure. Computing device 100 may include hardware devices 110, trusted execution areas 120A-C, computing processes 130A-C, kernel 140, and a network 150. It should be noted that other architectures for computing device 100 are possible, and that the implementations of the computing device utilizing embodiments of the disclosure are not necessarily limited to the specific architecture depicted.

Computing device 100 may be a single computing machine or multiple computing machines arranged in a homogenous or heterogeneous group (e.g., cluster, grid, server farm). Computing device 100 may include one or more rack mounted servers, workstations, desktop computers, notebook computers, tablet computers, mobile phones, palm-sized computing devices, personal digital assistants (PDAs), etc. In one example, computing device 100 may be a computing device implemented with x86 hardware from Intel® or AMD®. In another example, computing device 100 may be a computing device implemented with ARM®, PowerPC®, SPARC®, other hardware, or a combination thereof. In either example, computing device 100 may include one or more hardware devices 110.

Hardware devices 110 may provide hardware resources for performing computing tasks. In one example, one or more of the hardware devices 110 may correspond to a physical device of computing device 100. In another example, one or more of hardware devices 110 may be provided by hardware emulation and the corresponding physical device may be absent from computing device 100. For example, computing device 100 may be a server machine that does not include a graphics device (e.g., no integrated graphics device) or includes a graphics device that does not support a particular hardware feature (e.g., 3D rendering). Kernel 140 may provide the hardware feature of the hardware device by emulating a portion of the hardware resource (e.g., provide a virtualized graphics device). The emulation of a portion of a hardware resource may be provided by kernel 140, computing process 130A-C, another hardware resource, or a combination thereof. One or more of the hardware devices 110 may be combined or consolidated into one or more physical devices or may be partially or completely emulated as a virtual device. In the example in FIG. 1, hardware devices 110 may include one or more storage devices 112 and processors 114.

Storage devices 112 may include any device that is capable of storing data, such as physical memory devices including volatile memory devices (e.g., RAM, DRAM, SRAM), non-volatile memory devices (e.g., NVRAM), other types of memory devices, or a combination thereof. Storage devices 112 may also or alternatively include mass storage devices, such as hard drives (e.g., Hard Disk Drives (HDD)), solid-state storage (e.g., Solid State Drives (SSD)), other persistent data storage, or a combination thereof. Storage devices 112 may be capable of storing data 113A and data 113B.

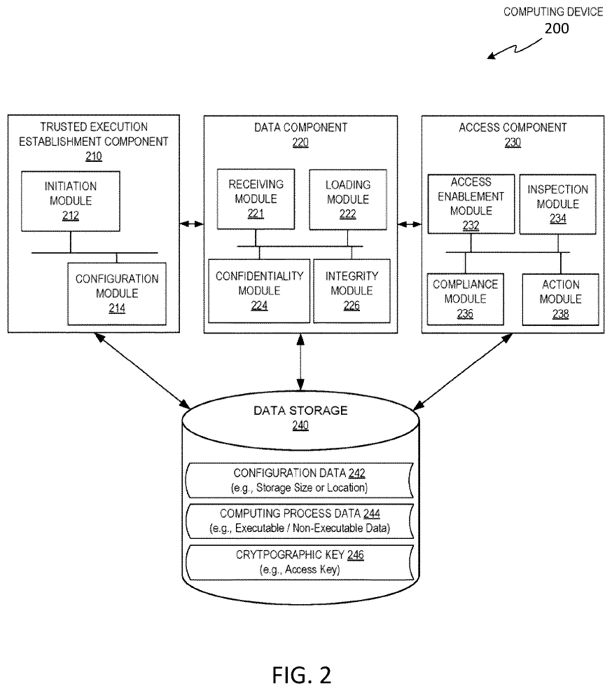

Data 113A and data 113B may be different copies of the same or similar data that is associated with one of the computing processes (e.g., 130A). In one example, data of computing process 130A may be received from a device that is internal or external to computing device 100. The data may be encrypted using a cryptographic key that was provided (e.g., determined, derived, generated, assigned) by computing device 100 or by a different computing device. Computing device 100 may make a copy of the received data in storage device 112, as shown by data 113A. The received data may be decrypted using the same cryptographic key or a derivative of the cryptographic key and may load the decrypted data into the trusted execution area 120A, as shown by data 113B. Data 113A and data 113B are discussed in more detail in the context of computing process data 244 of FIG. 2 and may both include the same decrypted content but may be encrypted using different cryptographic keys, cryptographic functions, cryptographic techniques, or a combination thereof.

Processors 114 may be communicably coupled to storage devices 112 and be capable of executing instructions encoding arithmetic, logical, or I/O operations. Processors 114 may include one or more general processors, Central Processing Units (CPUs), Graphical Processing Units (GPUs), Application Specific Integrated Circuits (ASICs), secure cryptoprocessors, Secure Elements (SE), Hardware Security Module (HSM), other processing unit, or a combination thereof. Processors 114 may be a single core processor, which may be capable of executing one instruction at a time (e.g., single pipeline of instructions) or a multi-core processor, which may simultaneously execute multiple instructions. Processors 114 may interact with storage devices 112 to provide one or more trusted execution areas 120A-C.

Each of the trusted execution areas 120A-C may be a security enhanced area within computing device 100 that may guard the data of one or more computing processes from being accessed by other computing processes. A trusted execution area may enhance security by enhancing confidentiality (e.g., reducing unauthorized access), integrity (e.g., reduce unauthorized modifications), availability (e.g., enable authorized access), non-repudiation (e.g., action association), other aspects of digital security or data security, or a combination thereof. Each of the trusted execution areas 120A-C may be referred to as an instance of a trusted execution area (i.e., instance of a trusted execution environment (TEE)) and may be associated with and guard data of a particular execution construct. The execution construct may be a virtual machine, container, computing process, thread, instruction stream, or a combination thereof. In one example, each of the trusted execution areas 120A-C may be established for a particular virtual machine and may guard data of the virtual machine from a hypervisor managing the virtual machine. In another example, each of the trusted execution areas 120A-C may be associated with a particular computing process (e.g., user space process, application) and may guard data of the particular computing process from being accessed by other equally privileged, higher privileged, or lower privileged computing processes (e.g., guard against higher privileged operating system processes).

Trusted execution areas 120A-C may provide features defined or offered by trusted execution environments (TEEs), trusted systems, trusted computing components, a trusted computing base (TCB), a trusted platform module (TPM), hardware security module(s) (HSM), secure element(s) (SE), other features, or a combination thereof. A trusted execution area may be established by a set of hardware devices 110 (e.g., processor and/or storage device) that include instructions (e.g., opcodes) to initiate, configure, and maintain the trusted execution area, as discussed in more detail below with regards to FIG. 2. In one example, one or more trusted execution areas may be implemented using Software Guard eXtensions® (SGX) provided by Intel®, Memory Encryption Technology provided by AMD® (e.g., Secure Encrypted Virtualization® (SEV), Secure Memory Encryption (SME, SME-ES), TrustZone® or Confidential Computing architecture provided by ARM®, other technology, or a combination thereof. In some or all of these examples, processors 114 may guard data using one or more trusted storage areas 122A-C.

Trusted storage area 122 may be an area of one or more storage devices 112 that stores data of a computing process. As shown in FIG. 1, trusted storage area 122 may correspond to trusted execution area 120A and may store data of computing process 130A in an encrypted form. The data may be encrypted and decrypted by hardware devices 110 using cryptographic input that includes one or more cryptographic keys. In one example, the cryptographic keys may be accessible to hardware devices 110 and may be inaccessible to operating system level processes executed by the hardware device 110. In another example, the cryptographic keys may be accessible to hardware devices 110 and one or more computing processes, such as, the computing process associated with the trusted execution area. In either example, the encryption and decryption performed by the hardware device 110 may be referred to as hardware based encryption, hardware level encryption, hardware assisted encryption, hardware enforced encryption, or other similar terms, or a combination thereof.

Trusted storage area 122 may include a portion of memory and may be referred to as an encrypted memory area. An encrypted memory area may be a contiguous or non-contiguous portion of virtual memory, logical memory, physical memory, other storage abstraction, or a combination thereof. The encrypted memory area may correspond to or be mapped to a portion of primary memory (e.g., main memory), auxiliary memory (e.g., solid state storage), adapter memory (e.g., memory of graphics card), other persistent or non-persistent storage, or a combination thereof. In one example, the encrypted memory area may be a portion of main memory associated with a particular process and the processor may encrypt the data when storing the data in the memory area and may decrypt the data when retrieving the data from the memory area. The data in the memory area may be transformed (e.g., encrypted or decrypted) before, during, or after it is stored in or retrieved from the memory area and may remain in an encrypted form while in the encrypted memory area.

Trusted storage area 122 may store the data in one or more storage units. The storage units may be logical or physical units of data storage for managing the data (e.g., storing, organizing, or accessing the data). A storage unit may include a contiguous or non-contiguous sequence of bytes or bits. In one example, a storage unit may be a virtual representation of underlying physical storage units, which may be referred to as physical storage blocks. Storage units may have a unit size that is the same or different from a physical block size provided by an underlying hardware resource. The storage unit may include volatile or nonvolatile data storage. In one example, storage units may be a memory segment and each memory segment may correspond to an individual memory page, multiple memory pages, or a portion of a memory page. In other examples, each of the storage units may correspond to a portion (e.g., block, sector) of a mass storage device (e.g., hard disk storage, solid state storage). The data in the storage units of trusted storage area 122 may be transmitted to other hardware devices using trusted IO 123.

Trusted IO 123 may enable the data of a computing process to be transmitted between hardware devices 110 in a security-enhanced manner. The data may be transmitted over one or more system buses, networks, or other communication channels in encrypted or partially encrypted form. This may be advantageous because transmitting the data in an encrypted form may limit the ability of the data to be snooped while being transmitted between hardware devices. As shown in FIG. 1, trusted IO 123 may enable the data of computing process 130A to be transmitted between trusted storage area 122 and trusted processor area 124A.

Trusted processor area 124A may be a portion of processor 114 that is associated with computing process 130A and guards data of computing process 130A from being accessed or modified by computing processes 130B-C. Trusted processor area 124A may include a portion of processor 114 that stores the data (e.g., CPU cache, processor memory or registers) and a portion of processor 114 that executes the data (e.g., processor core). A trusted processor area may store the data in an encrypted form as shown by trusted processor area 124A or in a decrypted form as shown by trusted processor area 124B. In either example, the data of a computing process may be protected from being accessed or modified by other processes via the design of the processor and encryption may not be required to ensure isolation of the data when the data is within the processor packaging (e.g., chip packaging).

As shown in FIG. 1, the same processor and storage device may be used to establish multiple instances of a trusted execution area (e.g., trusted execution areas 120A-C). Each instance may be established for a particular set of one or more computing processes and may be associated with a particular memory encrypted area. The instances of a trusted execution area may be provided by the same hardware (e.g., processor and memory) but each instance may be associated with a different memory encrypted area and a different set of one or more processes (e.g., set including an individual process or set of all VM processes).

Each instance may guard all or a portion of data of a computing process. For example, computing process 130C (e.g., application or VM) may be associated with both a trusted execution area (e.g., 120C) and an untrusted execution area (e.g., 121). In this situation, a first portion of the data of computing process 130C may be stored and/or executed within trusted execution area 120C and a second portion of the data of computing process 130C may be stored and/or executed within the untrusted execution area 121. The second portion may be stored in the same storage device as the first portion but the second portion may be stored in a decrypted form and may be executed by processor 114 in a manner that enables another process (e.g., multiple higher privileged processes) to access or modify the data. In either example, trusted execution area may be used to execute one or more of the computing processes 130A-C.

Each of the computing processes 130A-C may include one or more execution streams for executing programmed instructions. A stream of instructions may include a sequence of instructions that can be executed by one or more processors. Each of the computing processes may be managed by a kernel 140 or a part of kernel 140 (not shown). In one example, a computing process may be an instance of a computer program that is being executed and may contain executable program code and a state of the current activity. Multiple computing processes may be executed concurrently by a processing device that supports multiple processing units. The processing units may be provided by multiple processors or from a single processor with multiple cores or a combination thereof. A computing process may include one or more computing threads, such as a system thread, user thread, or fiber, or a combination thereof. A computing process may include a thread control block, one or more counters and a state (e.g., running, ready, waiting, start, done).

Computing processes 130A-C may be examples of first computing processes 131 and may correspond to one or more applications, containers, virtual machines, or a combination thereof. Applications may be programs executing with user space privileges and may be referred to as application processes, system processes, services, background processes, or user space processes. A user space process (e.g., user mode process or user privilege process) may have lower-level privileges that provide the user space process access to a user space portion of data storage without having access to a kernel space portion of data storage. In contrast, a kernel process may have higher privileges that provide the kernel process access to a kernel space portion and to user space portions that are not guarded by a trusted execution area. In one example, the privilege associated with a user space process may change during execution and a computing process executing in user space (e.g., user mode, user land) may be granted enhanced privileges by an operating system and function in kernel space (e.g., kernel mode, kernel land). This may enable a user space process to perform an operation with enhanced privileges. In another example, the privilege associated with a user space process may remain constant during execution and the user space process may request an operation be performed by another computing process that has enhanced privileges (e.g., operating in kernel space).

The privilege levels of a computing process may be the same or similar to protection levels of processor 114 (e.g., processor protection rings) and may indicate an access level of a computing process to hardware resources (e.g., virtual or physical resources). There may be multiple privilege levels assigned to the computing process. In one example, the privilege levels may correspond generally to either a user space privilege level or a kernel privilege level. The user space privilege level may enable a computing process to access resources assigned to the computing process but may restrict access to resources assigned to another user space or kernel space computing process. The kernel space privilege level may enable a computing process to access resources assigned to other kernel space or user space computing processes. In another example, there may be a plurality of privilege levels, and the privilege levels may include a first level (e.g., ring 0) associated with a kernel, a second and third level (e.g., ring 1-2) associated with device drivers, and a fourth level (e.g., ring 3) that may be associated with user applications.

Kernel 140 may include one or more programs that manage one or more of the computing processes 130A-C. Kernel 140 may execute as one or more kernel processes and manage access to physical or virtual resources provided by hardware devices 110. A kernel process may be an example of a second computing process 141, which may be a computing process that is associated with a higher privilege level (e.g., hypervisor privilege, kernel privilege, kernel mode, kernel space, protection ring 0). In one example, kernel 140 may be an operating system or part of an operating system (e.g., OS, host OS, guest OS) and the computing processes 130A-C may be different applications that are executing as user space processes. In another example, kernel 140 may be a hypervisor that provides hardware virtualization features and the computing processes 130A-C may be different virtual machines. In yet another example, kernel 140 may include a container runtime (e.g., Docker, Container Linux) that provides operating system level virtualization and the computing processes 130A-C may be different containers. In further examples, kernel 140 may provide a combination thereof (e.g., hardware virtualization and operating system level virtualization).

Kernel 140 may segregate storage devices 112 (e.g., main memory, hard disk) into multiple portions that are associated with different access privileges. At least one of the multiple portions may be associated with enhanced privileges and may be accessed by processes with enhanced privileges (e.g., kernel mode, kernel privilege) and another portion may be associated with diminished privileges and may be accessed by processes with both diminished privileges (e.g., user space mode, user space privilege) and those with enhanced privileges. In one example, the portion of storage devices 112 associated with the enhanced privileges may be designated as kernel space and the portion of storage devices 112 associated with the diminished privileges may be designated as user space. In other examples, there may be more or less than two portions.

When kernel 140 provides features of a hypervisor it may also be known as a virtual machine monitor (VMM) and may provide virtual machines with access to one or more features of the underlying hardware devices 110. A hypervisor may run directly on the hardware of computing device 100 (e.g., host machine) or may run on or within a host operating system (not shown). The hypervisor may manage system resources, including access to hardware devices 110. The hypervisor may be implemented as executable code and may emulate and export a bare machine interface to higher-level executable code in the form of virtual processors and guest memory. Higher-level executable code may comprise a standard or real-time operating system (OS), may be a highly stripped down operating environment with limited operating system functionality and may not include traditional OS facilities, etc.

FIG. 2 is a block diagram illustrating an exemplary computing device 200 that uses a trusted execution area to protect data of a computing process, in accordance with one or more aspects of the present disclosure. Computing device 200 may be the same or similar to computing device 100 of FIG. 1 and may include a trusted execution establishment component 210, a data component 220, an access component 230, and data storage 240. The components and modules discussed herein may be performed by any portion of a computing device. For example, one or more of the components or modules discussed below may be performed by processor hardware, processor firmware, a kernel, a driver, an application, other portion of an operating system, or a combination thereof.

More or fewer components or modules may be included without loss of generality. For example, two or more of the components may be combined into a single component, or features of a component may be divided into two or more components. In one implementation, one or more of the components may reside on different computing devices (e.g., on processor and memory controller).

Trusted execution establishment component 210 enables computing device 200 to establish one or more trusted execution areas for the computing processes executing on computing device 200. Establishing a trusted execution area may involve creating a new trusted execution environment or updating an existing trusted execution environment. Each trusted execution area may be associated with one or more computing processes and may store or execute data of the one or more computing processes. In one example, trusted execution establishment component 210 may include an initiation module 212 and a configuration module 214.

Initiation module 212 may enable computing device 200 to initiate the configuration of a trusted execution area by executing one or more instructions recognized by the processor (e.g., Intel SGX opcodes). The instructions may be called by a program associated with an application, operating system, hypervisor, BIOS, hardware adapter, other entity, or a combination thereof. In one example, a computing process may initiate the creation of the trusted execution area and may subsequently execute within the trusted execution area. In another example, a computing processes may initiate the creation of the trusted execution area and the trusted execution area may be used for another computing process. In either example, after the trusted execution area is initiated it may be configured by configuration module 214.

Configuration module 214 may enable computing device 200 to configure a trusted execution area to store or execute data of a computing process. Configuration module 214 may configure the trusted execution area in view of configuration data 242 that may be provided by a process initiating or using the trusted execution area, by a processor, storage device, other portion of computing device 200, or a combination thereof. Configuration data 242 may be provided as input before, during, or after the trusted execution area is initiated, created, or updated. As discussed above, a trusted execution area may include a trusted storage area, a trusted processor area, trusted IO, or a combination thereof and the configuration data 242 may include data for configuring one or more of these. For example, configuration data 242 may include an execution construct data (e.g., processes identifier (PID), virtual machine identifier (UUID)), a storage data (e.g., storage size or location), cryptographic data (e.g., encryption key, decryption key, seed, salt, nonce), other data, or a combination thereof. One or more of these may be configured or customize and associated with the trusted execution area for the computing process. In one example, the trusted execution area may include an encrypted storage area and the configuration data 242 may indicate a size of the encrypted storage area that will be allocated to store the computing processes (e.g., size of virtual memory for a trusted storage area).

Configuration module 214 may configure different aspects of the trusted execution area to use different cryptographic techniques. The different cryptographic techniques may use different cryptographic functions, cryptographic settings, cryptographic keys, cryptographic inputs, other cryptographic data, or a combination thereof. In one example, data of a computing process may be encrypted using a first cryptographic technique (e.g., encrypted using a transport key) when loaded by the processor and may be encrypted using a second cryptographic technique (e.g., encrypted using a storage key) when stored in the encrypted storage area. This may be advantageous because the data may be more vulnerable to attack when it is stored on a removable storage device (e.g., memory module) then when it is transferred over the system bus and therefore a different cryptographic technique may be used.

Data component 220 may enable computing device 200 to load data of a computing process to enhance the confidentiality and integrity of the data. The data of a computing process may be stored in data storage 240 as computing process data 244. Computing process data 244 may include executable data (e.g., machine code, instruction calls, opcodes), non-executable data (e.g., configuration data, parameter values, settings files), other data, or a combination thereof. In some examples, the computing process data 244 includes one or more file systems. In one example, data component 220 may include a receiving module 221, a loading module 222, a confidentiality module 224, and an integrity module 226.

Receiving module 221 may enable computing device 200 to receive computing process data 244 and store it in data storage 240. Receiving module 221 may receive computing process data 244 from one or more devices. In one example, receiving module 221 may receive computing process data 244 from an external device (e.g., remote client device) that is accessible over an external connection (e.g., network, internet, ethernet, or cellular connection) using a network adapter. The network adapter may write the data directly to data storage 240 (e.g., Direct Memory Access (DMA)) or may provide the data to the processor and the processor may write the data to data storage 240. In another example, receiving module 221 may receive computing process data 244 from an internal device (e.g., hard drive) that is accessible over an internal connection (e.g., internal data bus). In either example, receiving module 221 may store one or more copies of computing process data 244.

Loading module 222 may include instructions for loading computing process data 244 into a trusted execution area. Loading computing process data 244 may involve copying data, moving data, updating data, modifying data, or other action affecting data of a computing process. The process of loading computing process data 244 may involve copying data into the trusted processor area from the trusted storage area, copying data into the trusted storage area from an untrusted area, other copy operation, or a combination thereof. The trusted execution area may store the data of the computing process in the encrypted storage area and the loading may involve the processor receiving the data in an encrypted form over a bus from the encrypted storage area (e.g., retrieving data via trusted IO). The trusted execution area may be a trusted execution environment (TEE) that includes or is associated with a portion of memory and a portion of the processor and wherein the data of the computing process that is loaded into the trusted execution area may be accessible to the computing process and inaccessible to the kernel prior to the enabling.

Integrity module 226 may use the trusted execution area to enhance the integrity of computing process data 244. Data integrity may involve avoiding unauthorized changes to the data by maintaining and assuring the accuracy and consistency of the computing process data 244 during storage, retrieval, execution, or a combination thereof. Enhancing data integrity may be the same or similar to enhancing data quality or data validation and may reduce data corruption. Integrity module 226 may check the integrity of computing process data 244 and therefore the integrity of computing device 200. The check may be done before, during, or after the trusted execution area is established (e.g., attest in response to the initiation and before configuring).

Integrity module 226 may provide attestation to enhance data integrity. Attestation may enable a computing device to detect unauthorized changes to programs, hardware devices, other portions of computing device, or a combination thereof. The unauthorized changes may be the result of malicious, defective, or accidental actions by a program or hardware device. Attestation may involve local attestation where the data integrity is verified by a portion of computing device 200 or remote attestation where the data integrity is verified by another computing device (e.g., over network 150). In either example, the attestation may be performed non-anonymously or anonymously (e.g., Direct Anonymous Attestation (DAA)). Integrity module 226 may enhance data integrity using one or more features of confidentiality module 224.

Confidentiality module 224 may enable computing device 100 to enhance the confidentiality of computing process data 244. Enhancing the confidentiality of computing process data 244 may be the same or similar to enhancing the security of computing process data 244 by reducing access to the data by other computing processes, hardware devices, or a combination thereof. Confidentiality module 224 may implement the trusted storage area as an encrypted storage area that uses hardware based encryption. The encrypted storage area may be a contiguous portion of virtual memory of the computing process and the hardware based encryption may be provided by a central processing unit, memory device, other hardware device, or a combination thereof. The hardware based encryption may cause other computing processes to be unable to access content of the virtual memory of the computing process or to limit access to an encrypted version of the content in the virtual memory. Confidentiality module 224 may enable confidentiality to be waived or customized so that one or more other computing processes (e.g., a kernel process) can access a decrypted version of computing process data 244. Waiving confidentiality is discussed in more detail in regards to access component 230 and may be performed without waiving data integrity (e.g., data can be selectively accessed but not modified).

Access component 230 may enable computing device 200 to use a trusted execution area to reduce access to data of a first computing process without restricting the ability of a second computing process (e.g., management process) to inspect the data of the first computing process. In one example, the first computing process may be a user space process and the second computing process may be a part of an operating system that manages the user space process. In another example, the first computing process may be a set of computing processes of a virtual machine and the second computing process may be a part of an operating system or hypervisor that manages the virtual machine. In either example, access component 230 may include an access enablement module 232, an inspection module 234, a compliance module 236, and an action module 238.

Access enablement module 232 may be used to enable a second computing process (e.g., kernel process) to access data of the first computing process that is in the trusted execution area. The trusted execution area may be configured to protect data of the first computing process from all other computing processes but receiving module 221 may have made a copy of an encrypted version of the computing process data 244 and stored it in a location outside of the trusted execution area. In one example, access enablement module 232 may enable the second computing process to access the copy of the computing process data 244 by providing the second computing process with access to a cryptographic key 246. Cryptographic key 246 may be used as a decryption key, authentication key, access key, other key, or a combination thereof. The cryptographic key 246 may be the same key that was used to encrypt the computing process (e.g., symmetric key) or may be a mathematically related cryptographic key (e.g., asymmetric key, private key, public key). In another example, access enablement module 232 may enable the kernel to access computing process data 244 by adding information of a kernel process to an access list (e.g., white list, black list). For example, a data structure of the processor may be updated to include a process identifier of the second computing process and the under-lying hardware may perform the decryption. In either example, access enablement module 232 may update computing device 200 to enable the second computing process to access computing process data 244 before, during, or after the computing process data 244 is executed or accessed by the processor.

Inspection module 234 may enable the second computing process to inspect the stored copy of computing process data 244. As discussed above, the second computing process may be part of a kernel, which may include one or more programs that execute as one or more kernel processes. Each kernel process may be a computing process that is associated with a higher privilege level (e.g., kernel privilege, kernel mode, kernel space, protection ring 0). In one example, the higher level privilege may enable the kernel process to access the copy of the computing process data 244 while it is in an encrypted form and the kernel may use cryptographic key 246 to decrypt the encrypted computing process data 244. In another example, the kernel process may attempt to access computing process data 244 and a hardware device may compare the kernel process identification information (e.g., PID) with one or more approved or disapproved process identifiers (e.g., white list or black list). In response to the comparison, the hardware device may provide the kernel process with access to the computing process data 244. The kernel process may then receive computing process data 244 before, during, or after the computing process data 244 is decrypted by one of the hardware devices. The kernel process may or may not be aware that the computing process data 244 was previously encrypted and decrypted. In either example, the kernel may access the unencrypted version of computing process data 244 and make it available to compliance module 236.

Compliance module 236 may enable the second computing process to determine whether computing process data 244 is in compliance with one or more rules. Determining whether the data complies with the rules may be the same or similar to detecting compliance or performing a compliance inquiry and may involve analyzing and evaluating computing process data 244 to detect compliance or incompliance. The analysis may be static analysis, dynamic analysis, or a combination thereof. The static analysis may analyze and evaluate computing process data 244 while it is stored in data storage (e.g., anywhere in hierarchy of memory). Dynamic analysis may analyze and evaluate computing process data 244 while it is being executed by one or more processor cores (e.g., during runtime). The rules may be based on predetermined data (e.g., list of predetermined rules), machine learning data (e.g., machine learning model), other data, or a combination thereof.

The rules may include security rules, execution rules, other rules, or a combination thereof. Determining compliance in view of security rules may be the same or similar to evaluating antivirus rules and may involve detecting patterns of data that may correspond to malicious data (e.g., malicious executable code or configurations). Determining compliance in view of execution rules may involve detecting whether the computing process data 244 includes capabilities for loading other code after computing process data 244 starts to execute. This may be referred to as dynamic linking or dynamic loading and may be detected performed before, during, or after initiation or runtime (e.g., dynamic linked libraries, dynamically loadable modules).

Action module 238 may enable computing device 100 to take an action in response to determining whether or not the computing process data 244 is compliant. The action may be referred to as a compliance response and may initiated performed by the second computing process, by a kernel (e.g., hypervisor, OS), computing process (application, VM), hardware device (processor, memory device), other portion of computing device 200, or a combination thereof. The action may involve modifying the execution of the computing process by pausing, limiting, suspending, or terminating the execution of the non-compliant computing process. The action may also or alternatively involve providing a signal corresponding to the compliance (e.g., a compliance signal or uncompliant signal). Providing the signal may involve updating a shared storage location (e.g., shared memory or processor registry) or transmitting the signal to one or more computing devices. The signal may be transmitted internal to computing device 200 over an internal bus or transmitted external to computing device 200 to another computing device over network 150.

### Randomized File Block Encryption

As discussed above, the computing device 200 can include one or more file systems for data storage (e.g., computing process data 244). Each file system may be accessible to processes running on the computing device and users of the computing device. In addition, each file system may be accessible to external processes and users in communication with the computing device. The data stored in each file system may be encrypted for protection against unauthorized processes or users (e.g., hackers). In some cases, the data is encrypted (and periodically re-encrypted) in blocks to provide manageable encryption workloads. However, the order in which the file blocks are encrypted can indicate the significance of the data included in each file block. For example, important file blocks containing sensitive data may be encrypted (or re-encrypted) prior to file blocks containing non-sensitive data. In certain cases, such file blocks may have an increased vulnerability to coordinated attacks from unauthorized processes or users. As such, it may be advantageous to randomize the encryption process to eliminate patterns that expose file blocks to potential attacks and security compromises.

Accordingly, systems and methods for providing randomized encryption of file blocks are provided herein. In at least one embodiment, at least one encryption scheme is selected for a plurality of file blocks of a file system. At a first time, the plurality of file blocks are encrypted with the at least one encryption scheme in a first encryption order to produce a first plurality of encrypted file blocks. In some examples, the first plurality of encrypted file blocks are stored in the file system. At a second time, the plurality of file blocks are encrypted with the at least one encryption scheme in a second encryption order that is different than the first encryption order to produce a second plurality of encrypted file blocks. In certain examples, the second plurality of encrypted file blocks replace the first plurality of encrypted file blocks in the file system.

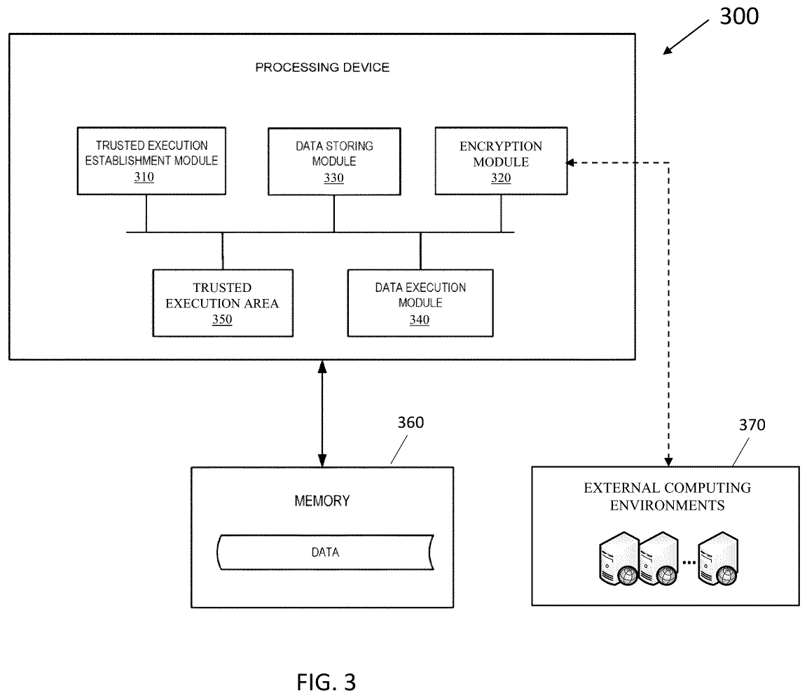

FIG. 3 depicts a block diagram of a computer system 300 operating in accordance with one or more aspects of the present disclosure. Computer system 300 may be the same or similar to computing devices 100, 200 of FIGS. 1 and 2, and may include one or more processors and one or more memory devices. In the example shown, computer system 300 may include a trusted execution establishment module 310, an encryption module 320, a data storing module 330, and a data execution module 340.

Trusted execution establishment module 310 may enable a processor to establish a trusted execution area 350. The trusted execution area 350 may include an encrypted storage area (e.g., an encrypted file system). The encrypted storage area may include a contiguous or non-continuous portion of virtual memory of a computing process. In one example, the trusted execution area 350 may be a trusted execution environment (TEE) that includes a portion of memory (e.g., trusted storage area) and a portion of the processor (e.g., trusted processor area).

Encryption module 320 may enable the processor to encrypt (and re-encrypt) data stored in one or more file systems of the computer system 300. For example, the encryption module 320 may encrypt data stored in a storage device 360. The storage device 360 may be a local storage device of the computer system 300 or a remote storage device (e.g., cloud-based server). In some examples, the encryption module 320 may encrypt data stored in an encrypted storage area of the trusted execution area 350. In one example, the encryption workloads are performed by one or more external computing environments 370 (e.g., cloud-based computing environments). In other examples, the encryption workloads may be performed by the processor.

The encryption module 320 is configured to encrypt file system data in discrete blocks (e.g., file blocks). Each file block may contain a particular type of data or data group. For example, a first file block may include user information, a second file block may include data corresponding to a first application, a third file block may include data corresponding to a second application, etc. In some examples, the groupings of file blocks corresponds to a sensitivity level of the data. For example, a first file block may include sensitive data and a second file block may include non-sensitive data. In one example, the encryption module 320 is configured select at least one encryption scheme for the file blocks; however, in other examples, the encryption scheme(s) may be selected or provided by one or more users of the computer system 300. The encryption module 320 may use the selected encryption schemes to encrypt the file blocks in different orders, as described in greater detail below.

Data storing module 330 may enable the processor to store the file blocks encrypted by the encryption module 320. In some examples, the data storing module 330 may store a copy of the file blocks encrypted by the encryption module 320. In one example, the data storing module 330 may only proceed with storing a copy of the data after receiving permission from the encryption module 320. As described above, encrypted file blocks may be stored in a file system located in the storage device 360 and/or the trusted execution area 350. The data may be stored at a storage location that is accessible to a one or more computing processes. In some examples, the encryption provided by the encryption module 320 corresponds to the target storage location of the data. For example, data stored in a file system located in the storage device 360 may be encrypted using a first cryptographic key (e.g., transport key, location independent key). Likewise, data stored in the trusted execution area 350 may be encrypted using a second cryptographic key (e.g., location dependent key).

Data execution module 340 may enable the processor to execute one or more computing processes associated with the encrypted file system data. In one example, the one or more computing processes may include kernel processes. In some examples, the one or more computing processes may include user processes configured to run in trusted and/or untrusted environments of the computer system 300. In one example, the data execution module 340 may inspect a copy of the encrypted data stored in the storage device 360 and determine in view of the inspection that the encrypted data is safe to access or otherwise use. The determination may be done before, during, or after the data is loaded or began executing.

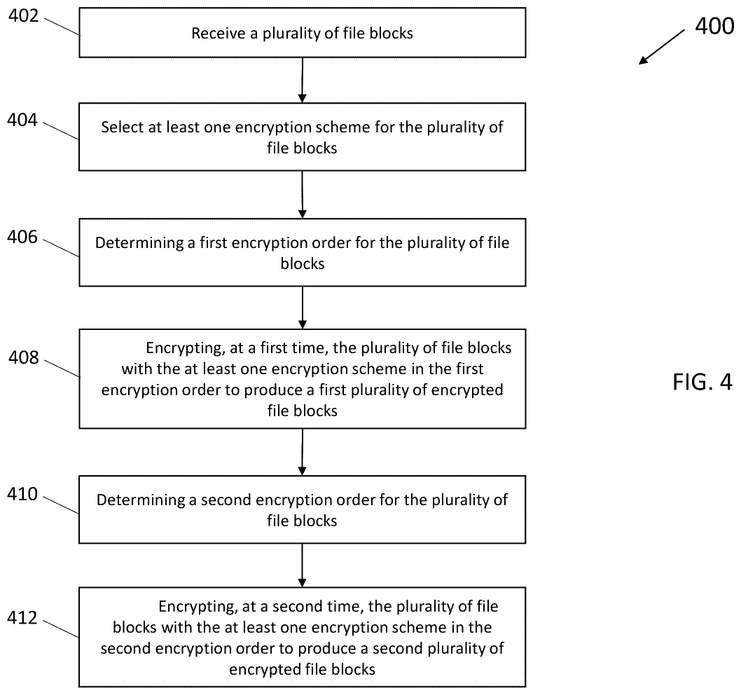

FIG. 4 is a flow diagram of a method 400 for providing randomized encryption of file blocks in accordance with aspects described herein. In one example, the method 400 is configured to be implemented by the computing device 300 of FIG. 3; however, in other examples, the method 400 may be implemented, at least in part, by at least one different computing system, controller, processor, etc. In some examples, the method 400 may be carried out, at least in part, by the encryption module 320.

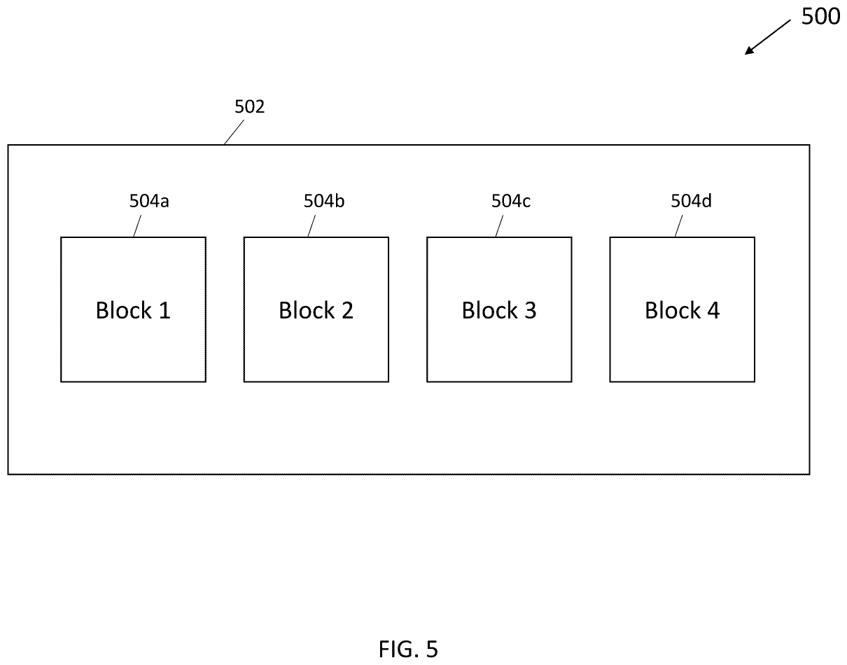

At block 402, a plurality of file blocks are received at the encryption module 320. The plurality of file blocks correspond to at least a portion of the data stored in a file system (e.g., on the storage device 360). In one example, the received file blocks correspond to copies of file blocks located on the storage device 306. The file blocks received at the encryption module 320 may be encrypted or unencrypted. FIG. 5 illustrates an example file system 502 including a plurality of file blocks 504. As shown, the plurality of file blocks 504 includes a first block 504a, a second block 504b, a third block 504c, and a fourth block 504d. In other examples, the plurality of file blocks 504 may include a different number of file blocks (e.g., three, five, etc.). Each file block 504 includes a data subset of the file system 502. As described above, the file blocks may correspond to particular categories or types of data (e.g., user data, application data, etc.). In some examples, the file blocks 504 are created (or formed) by the file system 502. However, in other examples, the file blocks 504 may be created by the encryption module 320 or another module of the computer system 300 (e.g., the data storing module 330).

At block 404, at least one encryption scheme is selected for the plurality of file blocks 504. The at least one encryption scheme may include elliptic curve cryptography (ECC), lattice-based cryptography, or any other suitable encryption scheme(s). In one example, the at least one encryption scheme is selected by the encryption module 320. For example, the encryption module 320 may analyze the file blocks 504 and select the encryption scheme best suited for each file block 504. In other examples, the at least one encryption scheme is selected by one or more users of the computer system 300 (e.g., via a user interface).

At block 406, the encryption module 320 determines a first encryption order for the plurality of file blocks 504. In this context, an encryption order corresponds to the order (or sequence) in which the plurality of file blocks 504 are encrypted. In other words, the encryption order represents the order in which the encryption workloads (e.g., the act of encrypting the data) are performed. In some examples, the encryption order may represent the order in which requests are sent to encrypt each file block 504. For example, requests may be sent to the external computing environments 370 to perform each encryption workload in accordance with the encryption order. In one example, the first encryption order is a random order (or sequence). The encryption module 320 may include a random order generator configured to generate the random encryption orders. In other examples, the encryption module 320 may receive the random encryption orders from an external order generator.

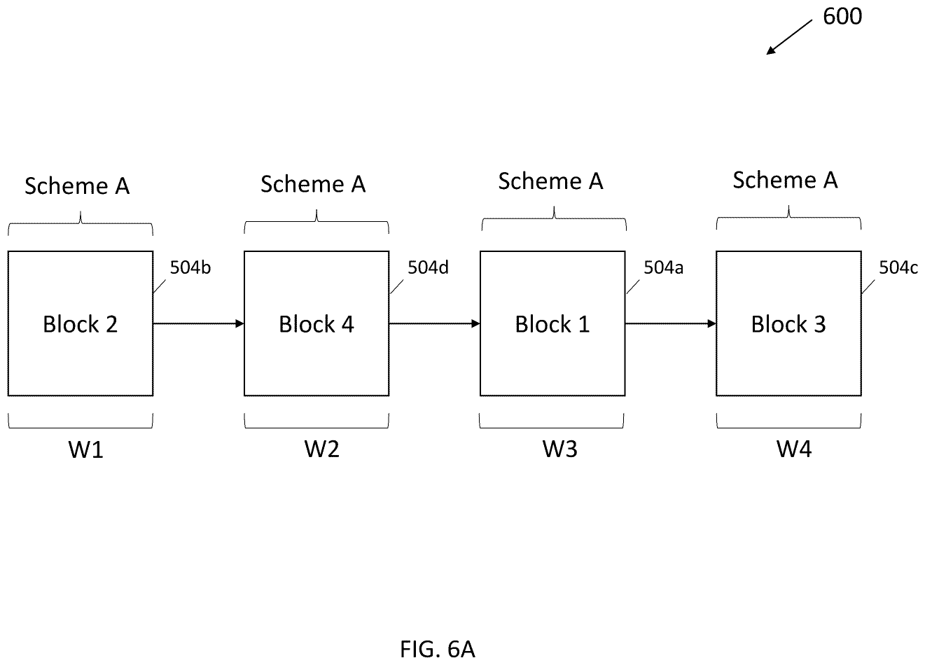

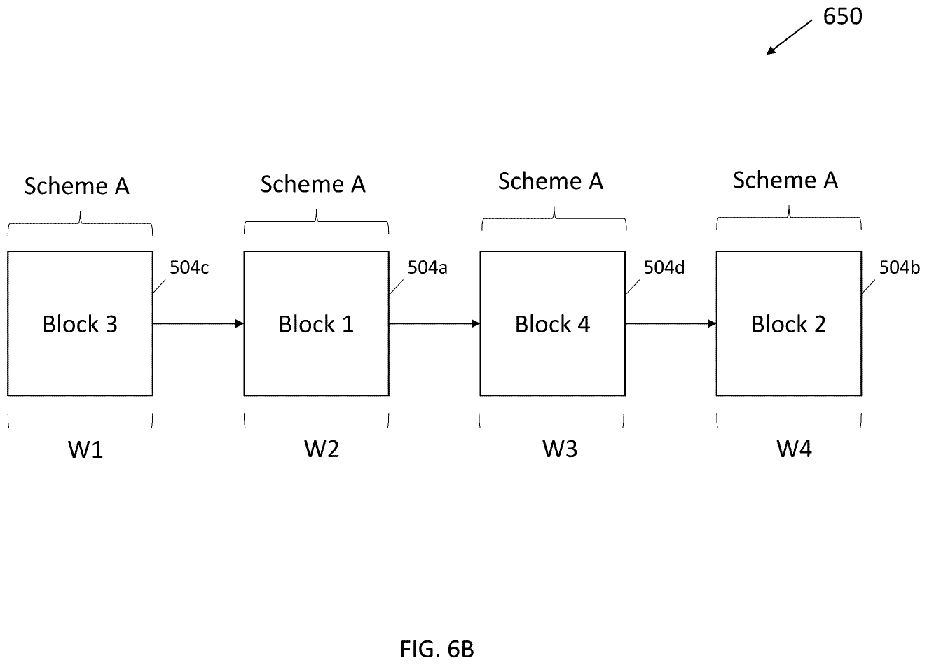

At block 408, the plurality of file blocks 504 are encrypted with the at least one encryption scheme in the first encryption order. The plurality of file blocks 504 are encrypted in the first encryption order at a first time to produce a first plurality of encrypted file blocks. In some examples, a copy of the plurality of file blocks 504 is encrypted to produce the first plurality of encrypted file blocks. If already encrypted, the plurality of file blocks 504 may be copied and decrypted prior to encryption (e.g., re-encryption). FIG. 6A illustrates an example encryption arrangement 600 used to produce the first plurality of encrypted file blocks. As shown, the first encryption order is “2-4-1-3”. As such, the second file block 504b is encrypted in a first workload slot W1, the fourth file block 504d is encrypted in a second workload slot W2, the first file block 504a is encrypted in a third workload slot W3, and the third file block 504c is encrypted in a fourth workload slot W4. In one example, each file block is encrypted with the same encryption scheme (e.g., Scheme A) to produce the first plurality of encrypted file blocks. In other examples, two or more file blocks may be encrypted using different encryption schemes (e.g., Scheme A, Scheme B, etc.). In some examples, the first plurality of encrypted file blocks replace the previous version of the plurality of file blocks 504 in the file system 502.

At block 410, the encryption module 320 determines a second encryption order for the plurality of file blocks 504. Like the first encryption order, the second encryption order may be a random order (e.g., generated by a random order generator). In one example, the first encryption order may be excluded from consideration for the second encryption order. For example, if the random order generated for the second encryption order matches the first encryption order, the random order may be discarded until a unique random order is generated. In some examples, encryption orders may be reused as long as they are not used consecutively. In other words, a third encryption order may be allowed to match the first encryption order, but not the second encryption order.

At block 412, the plurality of file blocks 504 are encrypted with the at least one encryption scheme in the second encryption order. The plurality of file blocks 504 are encrypted in the second encryption order at a second time to produce a second plurality of encrypted file blocks. In one example, the first plurality of encrypted file blocks may be copied and decrypted prior to encryption (e.g., re-encryption) to produce the second plurality of encrypted file blocks. FIG. 6B illustrates an example encryption arrangement 650 used to produce the second plurality of encrypted file blocks. As shown, the second encryption order is “3-1-4-2”. As such, the third file block 504c is encrypted in the first slot workload W1, the first file block 504a is encrypted in the second workload slot W2, the fourth file block 504d is encrypted in the third workload slot W3, and the second file block 504b is encrypted in the fourth workload slot W4. In one example, each file block is encrypted with the same encryption scheme (e.g., Scheme A) to produce the second plurality of encrypted file blocks. In some examples, the second plurality of encrypted file blocks replace the first plurality of encrypted file blocks in the file system 502.

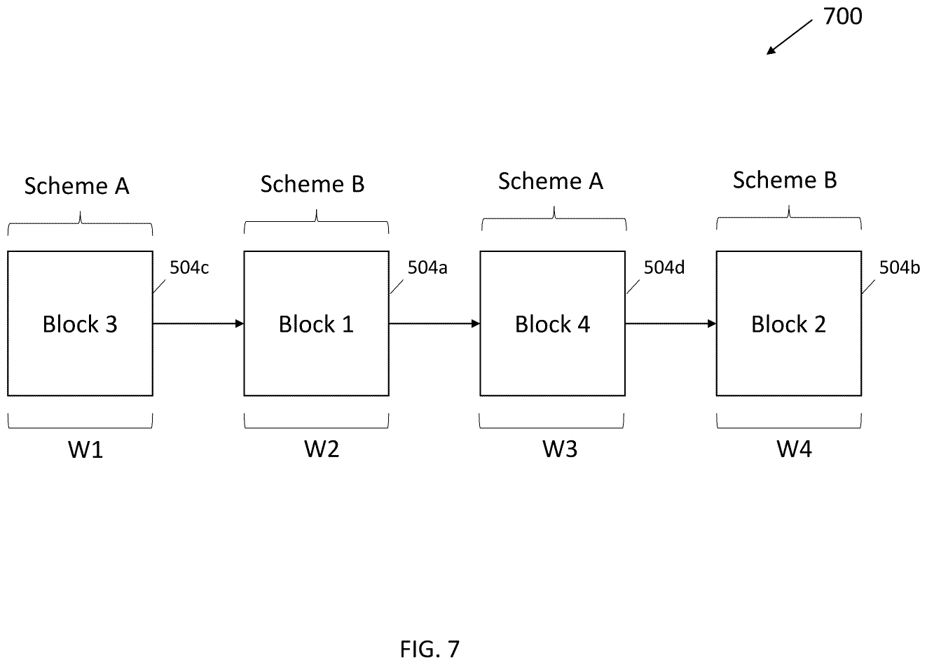

As described above, it should be appreciated that two or more encryption schemes may be used to encrypt the plurality of file blocks 504. For example, FIG. 7 illustrates an example encryption arrangement 700 using two different encryption schemes. The encryption arrangement 700 includes an encryption order of “3-1-4-2”. As such, the third file block 504c is encrypted in the first slot workload W1, the first file block 504a is encrypted in the second workload slot W2, the fourth file block 504d is encrypted in the third workload slot W3, and the second file block 504b is encrypted in the fourth workload slot W4. As shown, the third and fourth file blocks 504c, 504d are encrypted with a first encryption scheme (e.g., Scheme A) and the first and second file blocks are encrypted with a second encryption scheme (e.g., Scheme B).

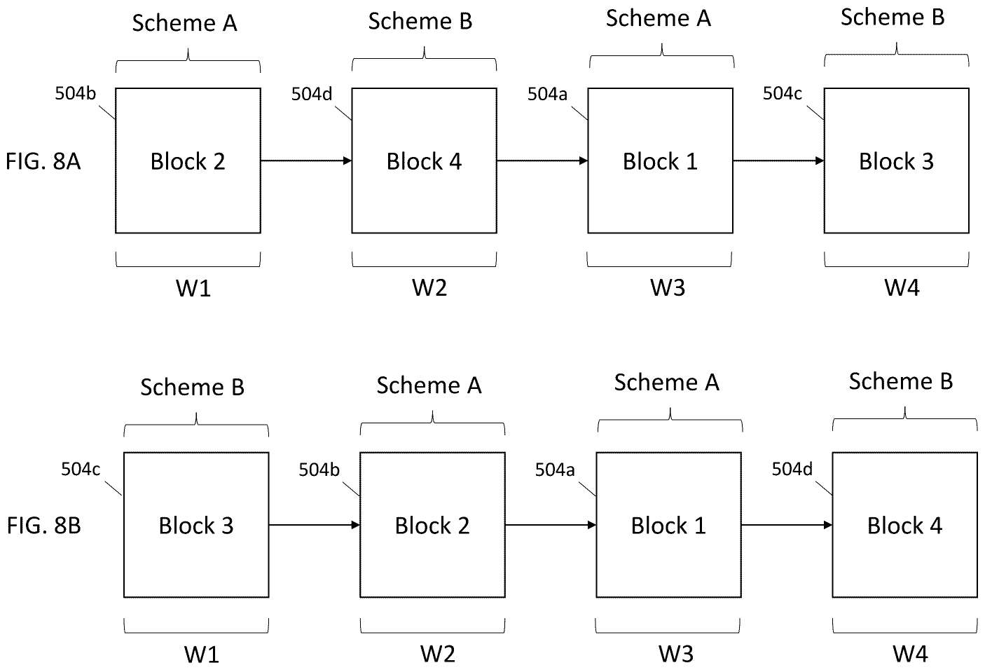

In some examples, the assignment of encryption schemes to each file block remains the same for each encryption round. For example, FIG. 8A illustrates an example first encryption round for the plurality of file blocks 504. The first encryption round has an encryption order of “2-4-1-3”. The second file block 504b is encrypted with Scheme A in the first workload slot W1, the fourth file block 504d is encrypted with Scheme B in the second workload slot W2, the first file block 504a is encrypted with Scheme A in the third workload slot W3, and the third file block 504c is encrypted with Scheme B in the fourth workload slot W4. Likewise, FIG. 8B illustrates an example second encryption round for the plurality of file blocks 504. The second encryption round has an encryption order of “3-2-1-4”. The third file block 504c is encrypted again with Scheme B but in the first workload slot W1, the second file block 504b is encrypted again with Scheme A but in the second workload slot W2, the first file block 504a is encrypted again with Scheme A in the third workload slot W3, and the fourth file block 504d is encrypted again with Scheme B but in the fourth workload slot W4. As such, the first and second blocks 504a, 504b are encrypted with Scheme A in both encryption rounds and the third and fourth blocks 504c, 504d are encrypted with Scheme B in both encryption rounds.

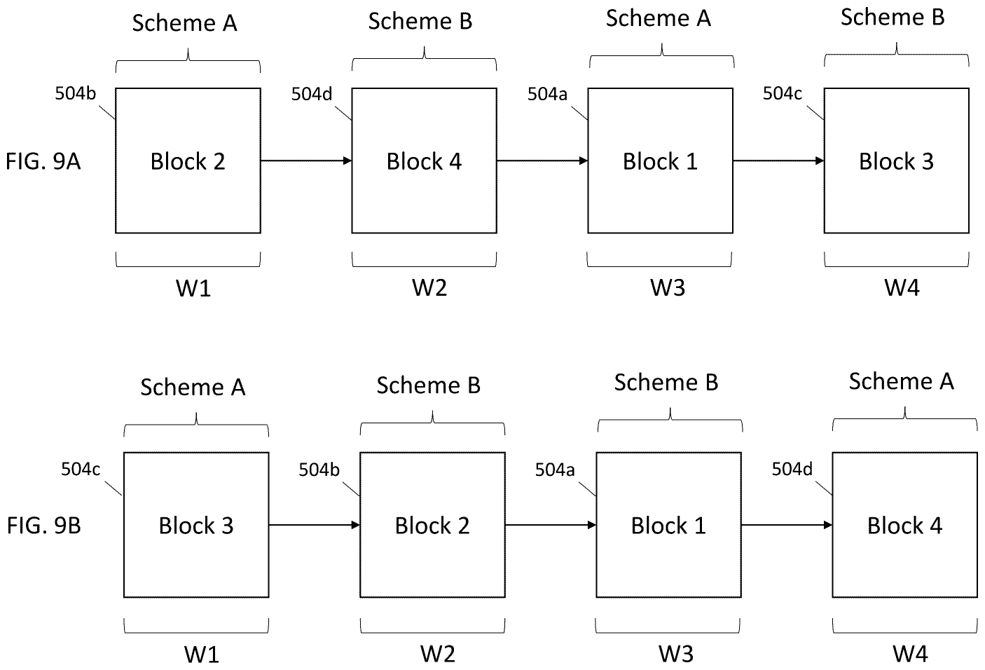

Alternatively, the assignment of encryption schemes to each file block may change between encryption rounds. For example, FIG. 9A illustrates another example first encryption round for the plurality of file blocks 504. The first encryption round has an encryption order of “2-4-1-3”. The second file block 504b is encrypted with Scheme A in the first workload slot W1, the fourth file block 504d is encrypted with Scheme B in the second workload slot W2, the first file block 504a is encrypted with Scheme A in the third workload slot W3, and the third file block 504c is encrypted with Scheme B in the fourth workload slot W4. FIG. 8B illustrates another example second encryption round for the plurality of file blocks 504. The second encryption round has an encryption order of “3-2-1-4”. The third file block 504c is now encrypted with Scheme A in the first workload slot W1, the second file block 504b is now encrypted with Scheme B in the second workload slot W2, the first file block 504a is now encrypted with Scheme B in the third workload slot W3, and the fourth file block 504d is now encrypted with Scheme A in the fourth workload slot W4. As such, the first and second file blocks 504a, 504b are encrypted with Scheme A in the first encryption round and with Scheme B in the second encryption round. Likewise, the third and fourth file blocks 504c, 504d are encrypted with Scheme B in the first encryption round and with Scheme A in the second encryption round. Changing the assignment of encryption schemes between encryption rounds may provide additional protection against unauthorized processes or users.

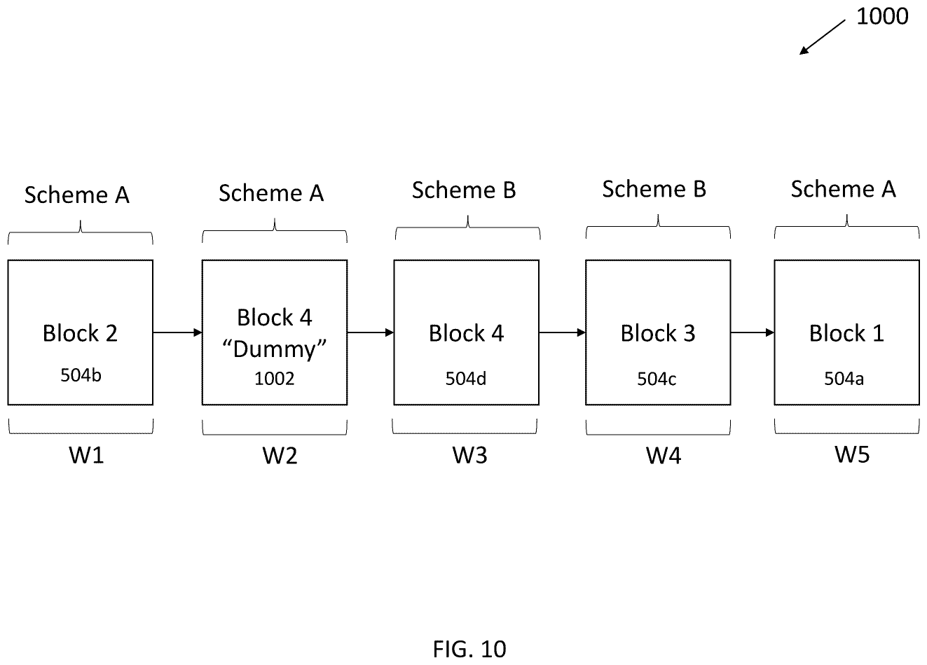

In some examples, the encryption module 320 can modify the encryption orders to provide additional data protection that extend beyond randomization. For example, the encryption orders may include one or more redundant workloads. The redundant workloads represent “dummy” workloads to mask the number of file blocks being encrypted. FIG. 10 illustrates an example encryption arrangement 1000 including a dummy workload 1002. In one example, the dummy workload 1002 corresponds to the fourth block 504d. In some examples, the dummy workload 1002 includes a copy of the fourth block 504d. In other examples, the dummy workload 1002 includes dummy (or fake) data that is the same size as the fourth block 504d. As shown, the encryption arrangement 1000 has an encryption order of “2-4-4-3-1”. The second file block 504b is encrypted with Scheme A in a first slot workload W1, the dummy workload 1002 is encrypted with Scheme A in a second workload slot W2, the fourth file block 504d is encrypted with Scheme B in a third workload slot W3, the third file block 504c is encrypted with Scheme B in a fourth workload slot W4, and the first file block 504a is encrypted with Scheme A in a fifth workload slot W5. In other examples, the dummy workload 1002 and the fourth file block 504d may be encrypted with the same encryption scheme (e.g., Scheme A or Scheme B). The dummy workload 1002 may function as a decoy to potential unauthorized processes or users that are monitoring the data encryption traffic. In some examples, the encrypted data corresponding to the dummy workload 1002 is discarded before the encrypted file blocks are stored in the file system.

While the example above includes a dummy workload 1002 corresponding to the fourth file block 504a, it should be appreciated that the dummy workload 1002 may correspond to any of the file blocks 504. For example, a random file block may be selected for the dummy workload 1002. In addition, the dummy workload 1002 may be positioned anywhere in the encryption order. In some examples, the dummy workload 1002 is placed in a workload slot immediately before or after the corresponding file block. However, in other examples, the dummy workload 1002 may be placed in a random position (e.g., workload slot). In some examples, multiple dummy workloads corresponding to one or more file blocks may be included in the encryption order. For example, two or more different file blocks may have corresponding dummy workloads. Alternatively, multiple dummy workloads corresponding to the same file block (e.g., file block 504d) may be included in the encryption order.

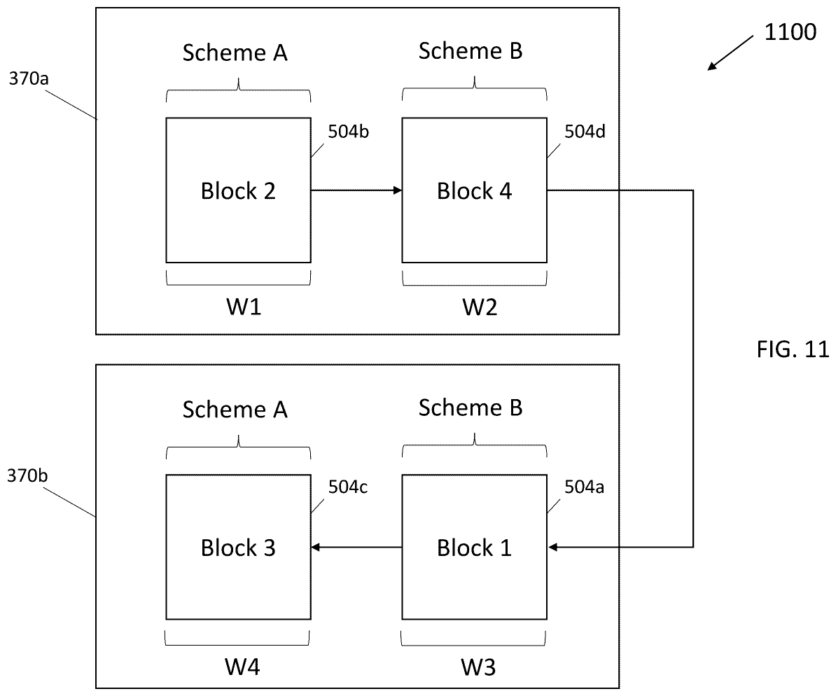

As described above, the encryption workloads may be performed by the external computing environment(s) 370. In some examples, the encryption module 320 can provide additional data protection by allocating encryption workloads across multiple computing environments (e.g., different services and/or machines). FIG. 11 illustrates an example encryption arrangement 1100 including encryption workloads performed in a first computing environment 370a and a second computing environment 307b. In one example, the first computing environment 370a corresponds to a first computing service (e.g., AWS) and the second computing environment 370b corresponds to a second computing service (e.g., Microsoft Azure). In some examples, the first and second computing environments 370a, 370b correspond to different instances of the same computing service. In some examples, the first computing environment 370a corresponds to a first container of a containerized application and the second computing environment 370b corresponds to a second container of the containerized application. In some examples, the first computing environment 370a corresponds to a first computing machine (e.g., a server) and the second computing environment 370b corresponds to a second computing machine. In some examples, the first and second computing machines may have different geographic locations. In other examples, the first and second computing machines may have the same geographic location (e.g., located in the same data center).

As shown, the encryption arrangement 1100 has an encryption order of “2-4-1-3”. The second file block 504b is encrypted in the first computing environment 370a with Scheme A in a first workload slot W1, the fourth file block 504d is encrypted in the first computing environment 370a with Scheme B in a second workload slot W2, the first file block 504a is encrypted in the second computing environment 370b with Scheme B in a third workload slot W3, and the third file block 504c is encrypted in the second computing environment 370b with Scheme A in a fourth workload slot W4. The encryption workloads may be performed in chronological order from slot W1 to W4. In other examples, at least a portion of the workloads may be performed in parallel. For example, the first workload slot W1 may occur in parallel with the third workload slot W3 and the second workload slot W2 may occur in parallel with the fourth workload slot W4. In some examples, the encryption order may correspond to the order of the workload requests sent to the computing environments 370a, 370b. In such examples, the workloads may be performed at times selected by the computing environments 370a, 370b (or the associated computing services).

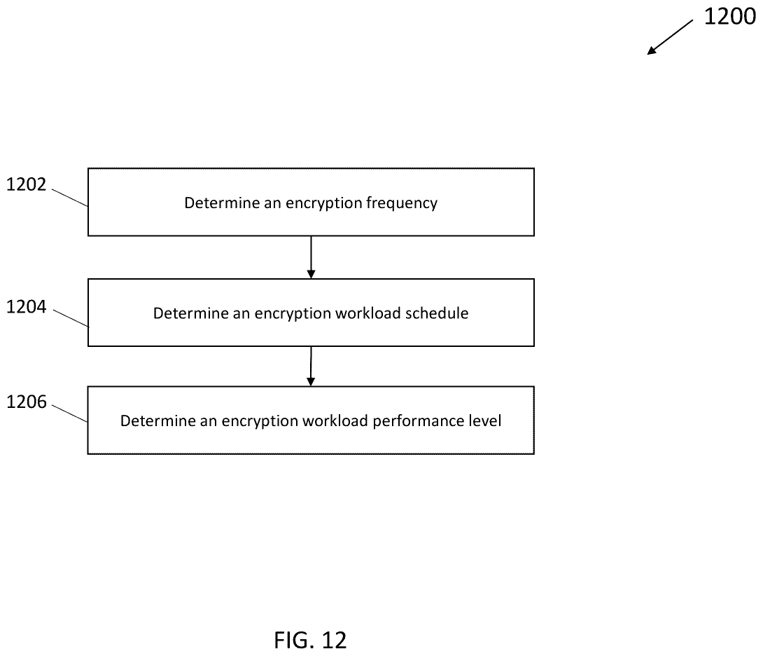

In some examples, the encryption module 320 is configured to generate an encryption profile for the file system 502 (or plurality of file blocks 504). The encryption profile may be used to encrypt (and re-encrypt) the plurality of file blocks 504 (e.g., as done in method 400 of FIG. 4). FIG. 12 is a flow diagram of a method 1200 for generating an encryption profile in accordance with aspects described herein. In one example, the method 1200 is configured to be implemented by the computing device 300 of FIG. 3; however, in other examples, the method 1200 may be implemented, at least in part, by at least one different computing system, controller, processor, etc. In some examples, the method 1200 may be carried out, at least in part, by the encryption module 320. In certain examples, the method 1200 is performed prior to the initial encryption of the plurality of file blocks 504.

At block 1202, the encryption module 320 determines an encryption frequency for the file system 502. The encryption frequency defines a periodic interval at which the plurality of file blocks 504 are re-encrypted. For example, the encryption frequency may set the timing between blocks 408 and 412 of the method 400. The encryption frequency may be any suitable frequency (e.g., once an hour, once a day, once a week, etc.). In some examples, the encryption module 320 may analyze the file blocks 504 and select the encryption frequency best suited for the file system 502. File systems that store sensitive data may be encrypted more often than file systems storing only non-sensitive data. In other examples, the encryption frequency is selected by one or more users of the computer system 300 (e.g., via a user interface). In some examples, different portions of the file system 502 may have different encryption frequencies. For example, file blocks corresponding to sensitive data may have higher encryption frequencies relative to non-sensitive file blocks. As such, multiple encryption frequencies may be included in the encryption profile for the file system 502.

At block 1204, the encryption module 320 determines an encryption workload schedule for the file system 502. The encryption workload schedule defines periods of times that the file blocks 504 may be encrypted. In other words, the encryption workload schedule sets the criteria for scheduling the encryption workloads. In some examples, the encryption module 320 may analyze the file blocks 504 and configure the encryption workload schedule best suited for the file system 502. There may be different costs associated with performing the encryption workloads at specific times of the day. For example, it can be more expensive to perform workloads during on-peak demand periods (e.g., regular business hours) compared to off-peak demand periods (e.g., overnight). Such on-peak/off-peak cost differentials may correspond to the availability of computing services and the price of utilities (e.g., electricity). In some examples, it may be more critical to re-encrypt file systems that store sensitive data rather than file systems storing only non-sensitive data. As such, encryption workloads associated with sensitive file systems may be scheduled during on-peak and off-peak demand periods, whereas encryption workloads associated with non-sensitive file systems may be scheduled only during off-peak demand periods.

In some examples, the encryption module 320 may analyze the plurality of file blocks 504 to assess the significance of the data included in the file blocks. In one example, the significance of the data included in the plurality of file blocks 504 is compared to a significance threshold. The plurality of file blocks 504 may be scheduled during off-peak demand periods in response to the comparison result falling below the significance threshold (e.g., the data being determined as non-sensitive). Likewise, the plurality of file blocks 504 may be scheduled during on-peak and off-peak demand periods in response to the comparison result rising above the significance threshold (e.g., the data being determined as sensitive). In other examples, the significance assessment of the data included in the file blocks may be performed one or more users of the computer system 300. The one or more users can provide a rating for the plurality of file blocks 504 indicating the level of sensitivity (e.g., via a user interface). The encryption module 320 may compare the user-provided rating to the significance threshold to determine the encryption workload schedule. In some examples, different portions of the file system 502 may have different encryption workload schedules. For example, file blocks corresponding to sensitive data may be scheduled during on-peak and off-peak demand periods and file blocks corresponding to non-sensitive data may be scheduled only during off-peak demand periods. As such, multiple encryption workload schedules may be included in the encryption profile for the file system 502.

At block 1206, the encryption module 320 determines an encryption workload performance level for the file system 502. The encryption workload performance level defines the desired processing rate for performing the encryption workloads. In other words, the encryption workload performance level sets the speed at which the file system 502 is encrypted. In some examples, the encryption module 320 may analyze the file blocks 504 and determine the encryption workload performance level best suited for the file system 502. There may be different costs associated with performing the encryption workloads at different processing rates. For example, it can be more expensive to perform workloads at faster processing rates compared to slower processing rates. In some examples, it may critical to re-encrypt file systems that store sensitive data faster than file systems storing only non-sensitive data. As such, encryption workloads associated with sensitive file systems may be assigned to higher (or faster) encryption workload performance levels, whereas encryption workloads associated with non-sensitive file systems may be assigned to lower (or slower) encryption workload performance levels. Likewise, it may desired to encrypt file systems storing frequently accessed data (e.g., in cache memory) at faster rates compared to file systems storing data that is accessed intermittently (e.g., in deep-storage).

In some examples, the encryption module 320 may analyze the plurality of file blocks 504 to assess the significance of the data included in the file blocks. In one example, the significance of the data included in the plurality of file blocks 504 is compared to a significance threshold. In some examples, the significance threshold may be the same threshold as used in block 1204, however, in other examples, the thresholds may be different. The plurality of file blocks 504 may be assigned to computing environments, services, and/or machines capable of providing lower encryption workload performance levels in response to the comparison result falling below the significance threshold (e.g., the data being determined as non-sensitive). Likewise, the plurality of file blocks 504 may be assigned to computing environments, services, and/or machines capable of providing higher encryption workload performance levels in response to the comparison result rising above the significance threshold (e.g., the data being determined as sensitive). In other examples, the significance assessment of the data included in the file blocks may be performed by one or more users of the computer system 300. The one or more users can provide a rating for the plurality of file blocks 504 indicating the level of sensitivity (e.g., via a user interface). In some examples, the user-provided rating may be the same rating used in block 1204; however, in other examples, the ratings may be different. The encryption module 320 may compare the user-provided rating to the significance threshold to determine the encryption workload performance level. In some examples, different portions of the file system 502 may have different encryption workload performance levels. For example, file blocks corresponding to sensitive data (or frequently accessed data) may be assigned to computing environments, services, and/or machines capable of providing higher encryption workload performance levels compared to the file blocks corresponding to non-sensitive data or intermittingly accessed data). As such, multiple encryption workload performance levels may be included in the encryption profile for the file system 502.

In one example, the encryption profile for the file system 502 is stored in the data storage device 360. The encryption profile may be provided to the encryption module 320 prior to the initial encryption of the file system 502. In some examples, the encryption profile is provided to the encryption module 320 prior to each re-encryption of the file system 502. It should be appreciated that the encryption profile may be updated periodically to account for changes to the file system 502 (or the plurality of file blocks 504).

As described above, systems and methods for providing randomized encryption of file blocks are provided herein. In at least one embodiment, at least one encryption scheme is selected for a plurality of file blocks of a file system. At a first time, the plurality of file blocks are encrypted with the at least one encryption scheme in a first encryption order to produce a first plurality of encrypted file blocks. In some examples, the first plurality of encrypted file blocks are stored in the file system. At a second time, the plurality of file blocks are encrypted with the at least one encryption scheme in a second encryption order that is different than the first encryption order to produce a second plurality of encrypted file blocks. In certain examples, the second plurality of encrypted file blocks replace the first plurality of encrypted file blocks in the file system.

### Some Examples of Computing Devices and Information Handling Systems

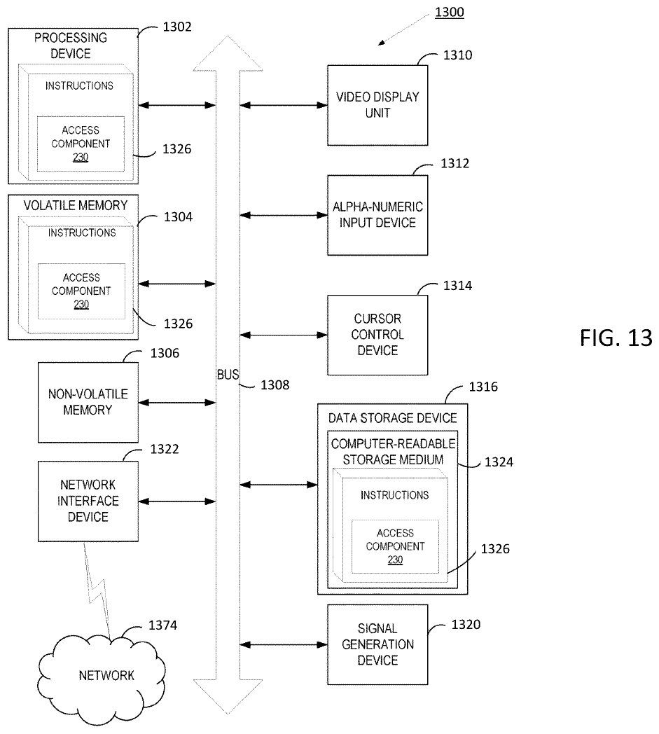

FIG. 13 depicts a block diagram of a computer system operating in accordance with one or more aspects of the present disclosure. In various illustrative examples, computer system 1300 may correspond to computing device 100, 200, or 300 of FIGS. 1-3. Computer system 1300 may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical environment, but requests for a hard disk or memory may be managed by a virtualization layer of a computing device to translate these requests to the underlying physical computing hardware resources. This type of virtualization results in multiple VMs sharing physical resources.

In certain implementations, computer system 1300 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1300 may include a processing device 1302, a volatile memory 1304 (e.g., random access memory (RAM)), a non-volatile memory 1306 (e.g., read-only memory (ROM) or electrically-erasable programmable ROM (EEPROM)), and a data storage device 1316, which may communicate with each other via a bus 1308.

Processing device 1302 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 1300 may further include a network interface device 1322. Computer system 1300 also may include a video display unit 1310 (e.g., an LCD), an alphanumeric input device 1312 (e.g., a keyboard), a cursor control device 1314 (e.g., a mouse), and a signal generation device 1320.

Data storage device 1316 may include a non-transitory computer-readable storage medium 1324 on which may store instructions 1326 encoding any one or more of the methods or functions described herein, including instructions for implementing methods 400 or 1200 and for encoding components 210, 220, and 230 of FIG. 2.

Instructions 1326 may also reside, completely or partially, within volatile memory 1304 and/or within processing device 1302 during execution thereof by computer system 1300, hence, volatile memory 1304 and processing device 1302 may also constitute machine-readable storage media.

While computer-readable storage medium 1324 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

Other computer system designs and configurations may also be suitable to implement the system and methods described herein. The following examples illustrate various implementations in accordance with one or more aspects of the present disclosure.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

### Terminology

The phrasing and terminology used herein is for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for providing randomized encryption for file blocks, comprising:
receiving a plurality of file blocks;
selecting at least one encryption scheme for the plurality of file blocks;
determining a first encryption order for the plurality of file blocks;
encrypting, at a first time, the plurality of file blocks with the at least one encryption scheme in the first encryption order to produce a first plurality of encrypted file blocks;
determining a second encryption order for the plurality of file blocks, the second encryption order being different from the first encryption order; and
encrypting, at a second time, the plurality of file blocks with the at least one encryption scheme in the second encryption order to produce a second plurality of encrypted file blocks.

2. The method of claim 1, wherein the first and second encryption orders are random orders.

3. The method of claim 2, wherein determining the first and second encryption orders for the plurality of file blocks includes receiving random encryption orders from a random order generator.

4. The method of claim 1, wherein selecting the at least one encryption scheme for the plurality of file blocks includes selecting a first encryption scheme and a second encryption scheme, the second encryption scheme being different than the first encryption scheme.

5. The method of claim 4, wherein a first portion of the plurality of file blocks are encrypted with the first encryption scheme and a second portion of the plurality of file blocks are encrypted with the second encryption scheme.

6. The method of claim 4, wherein at least one file block encrypted with the first encryption scheme to produce the first plurality of encrypted file blocks is encrypted with the second encryption scheme to produce the second plurality of encrypted file blocks.

7. The method of claim 1, wherein each file block of the plurality of file blocks includes a portion of data from a file system.

8. The method of claim 7, further comprising:
evaluating a significance of the data included in the plurality of file blocks; and
determining an encryption frequency based on the significance of the plurality of file blocks.

9. The method of claim 8, wherein an amount of time between the first time and the second time corresponds to the encryption frequency.

10. The method of claim 7, further comprising:
evaluating a significance of the data included in the plurality of file blocks;
comparing the significance of the data to a significance threshold; and
scheduling the encryptions of the plurality of file blocks based on a result of the comparison to the significance threshold.

11. The method of claim 10, further comprising:
in response to a comparison result falling below the significance threshold, scheduling the encryptions of the plurality of file blocks during off-peak demand periods; and
in response to a comparison result rising above the significance threshold, scheduling the encryptions of the plurality of file blocks during on-peak and/or off-peak demand periods.

12. The method of claim 11, wherein a first cost associated with performing the encryptions of the plurality of file blocks during off-peak demand periods is less than a second cost associated with performing the encryptions of the plurality of file block during on-peak demand periods.

13. The method of claim 7, further comprising:
evaluating a significance of the data included in the plurality of file blocks;
comparing the significance of the data to a significance threshold; and
selecting at least one computing service to perform the encryptions of the plurality of file blocks based on a result of the comparison to the significance threshold.

14. The method of claim 13, further comprising:
in response to a comparison result falling below the significance threshold, selecting at least one first computing service configured to perform the encryptions of the plurality of file blocks at a first processing rate; and
in response to a comparison result rising above the significance threshold, selecting at least one second computing service configured to perform the encryptions of the plurality of file blocks at a second processing rate, the second processing rate being faster than the first processing rate.

15. The method of claim 1, further comprising:
storing the first plurality of encrypted file blocks in a file system; and
replacing the first plurality of encrypted file blocks with the second plurality of encrypted file blocks.

16. A system for providing randomized encryption for file blocks, comprising:
at least one memory for storing computer-executable instructions; and
at least one processor for executing the instructions stored on the memory, wherein execution of the instructions programs the at least one processor to perform operations comprising:
receiving a plurality of file blocks;
selecting at least one encryption scheme for the plurality of file blocks;
determining a first encryption order for the plurality of file blocks;
encrypting, at a first time, the plurality of file blocks with the at least one encryption scheme in the first encryption order to produce a first plurality of encrypted file blocks;
determining a second encryption order for the plurality of file blocks, the second encryption order being different from the first encryption order; and
encrypting, at a second time, the plurality of file blocks with the at least one encryption scheme in the second encryption order to produce a second plurality of encrypted file blocks.

17. The system of claim 16, wherein the first and second encryption orders are random orders.

18. The system of claim 17, wherein determining the first and second encryption orders for the plurality of file blocks includes receiving random encryption orders from a random order generator.

19. The system of claim 16, wherein selecting the at least one encryption scheme for the plurality of file blocks includes selecting a first encryption scheme and a second encryption scheme, the second encryption scheme being different than the first encryption scheme.

20. The system of claim 19, wherein a first portion of the plurality of file blocks are encrypted with the first encryption scheme and a second portion of the plurality of file blocks are encrypted with the second encryption scheme.

21. The system of claim 19, wherein at least one file block encrypted with the first encryption scheme to produce the first plurality of encrypted file blocks is encrypted with the second encryption scheme to produce the second plurality of encrypted file blocks.

22. The system of claim 16, wherein each file block of the plurality of file blocks includes a portion of data from a file system.

23. The system of claim 16, wherein execution of the instructions programs the at least one processor to perform operations further comprising:
evaluating a significance of the data included in the plurality of file blocks; and
determining an encryption frequency based on the significance of the plurality of file blocks.

24. The system of claim 23, wherein an amount of time between the first time and the second time corresponds to the encryption frequency.

25. The system of claim 16, wherein execution of the instructions programs the at least one processor to perform operations further comprising:
evaluating a significance of the data included in the plurality of file blocks;
comparing the significance of the data to a significance threshold; and
scheduling the encryptions of the plurality of file blocks based on a result of the comparison to the significance threshold.

26. The system of claim 25, wherein execution of the instructions programs the at least one processor to perform operations further comprising:
in response to a comparison result falling below the significance threshold, scheduling the encryptions of the plurality of file blocks during off-peak demand periods; and
in response to a comparison result rising above the significance threshold, scheduling the encryptions of the plurality of file blocks during on-peak and/or off-peak demand periods.

27. The system of claim 26, wherein a first cost associated with performing the encryptions of the plurality of file blocks during off-peak demand periods is less than a second cost associated with performing the encryptions of the plurality of file block during on-peak demand periods.

28. The system of claim 16, wherein execution of the instructions programs the at least one processor to perform operations further comprising:
evaluating a significance of the data included in the plurality of file blocks;
comparing the significance of the data to a significance threshold; and
selecting at least one computing service to perform the encryptions of the plurality of file blocks based on a result of the comparison to the significance threshold.

29. The system of claim 28, wherein execution of the instructions programs the at least one processor to perform operations further comprising:
in response to a comparison result falling below the significance threshold, selecting at least one first computing service configured to perform the encryptions of the plurality of file blocks at a first processing rate; and
in response to a comparison result rising above the significance threshold, selecting at least one second computing service configured to perform the encryptions of the plurality of file blocks at a second processing rate, the second processing rate being faster than the first processing rate.

30. The system of claim 16, wherein execution of the instructions programs the at least one processor to perform operations further comprising:
storing the first plurality of encrypted file blocks in a file system; and
replacing the first plurality of encrypted file blocks with the second plurality of encrypted file blocks.
